(19) United States
(12) Patent Application Publication
(10) Pub. No.: US 2015/0300988 A1
(43) Pub. Date: Oct. 22, 2015

(54) PSC ANCHORAGE FOR MONITORING A STATUS CHANGE OF PS STEEL MEMBER AND PSC GIRDER USING THE SAME

(71) Applicant: Research & Business Foundation SUNGKYUNKWAN UNIVERSITY, Suwon-si (KR)

(72) Inventors: Seunghee PARK, Seongnam-si (KR); Junkyeong KIM, Namyangju-si (KR); Ju Won KIM, Suwon-si (KR)

(73) Assignee: Research & Business Foundation SUNGKYUNKWAN UNIVERSITY, Suwon-si (KR)

(21) Appl. No.: 14/688,204

(22) Filed: Apr. 16, 2015

(30) Foreign Application Priority Data
Apr. 16, 2014 (KR) 10-2014-0045405

(51) Int. Cl. G01N 27/80; G01N 3/08; G01N 3/02; E04C 5/08; E04C 5/12

(52) U.S. Cl. CPC G01N 27/80; E04C 5/08; E04C 5/12; G01N 3/02; G01N 3/08

(57) ABSTRACT

Provided herein is a PSC anchorage and a PSC girder using the same, the PSC anchorage including an anchorage plate having a central hole through which a PS steel member penetrates; a protruding unit protruding from the anchorage plate, and through which the PS steel member penetrates; and a metering unit configured to measure information on a state of the PS steel member.

### CROSS-REFERENCE TO RELATED APPLICATION

This application claims the benefit of priority under 35 U.S.C. §119(a) of Korean Patent Application No. 10-2014-0045405, filed on Apr. 16, 2014, in the Korean Intellectual Property Office, the entire disclosure of which is incorporated herein by reference for all purposes.

### BACKGROUND

1. Field

The following description relates to a PSC anchorage for monitoring a status change of a PS steel member and a PSC girder using the same.

2. Description of Related Art

A girder is generally placed under a base plate of an upper structure of a bridge which is directly subjected to the load of vehicles and which is configured to bear the upper load and to transfer the load to a lower structure of an abutment or pier.

Although such a girder has a large compressive force, it has a low tensile force, and thus when using a girder made of concrete, since concrete has a low bending stress, problems may occur where the girder fails to serve its role properly and cracks.

In order to resolve these problems, a PSC (Pre-Stressed Concrete) girder is being used wherein a compressive stress has been applied in advance in order to offset the tensile stress that may occur in the concrete.

According to the aforementioned technology, the magnitude and distribution of the stress that acts on a PS steel member inside the PSC girder due to a given load may be calculated, and then the PS steel member may be pre-stressed so that it may offset the stress acting thereon.

However, a difference may occur between a designed tensile force and the actual tensile force due to various factors such as the terms period of use, load history, concrete creep and dry contraction, relaxation of the PS steel member, damage in the anchorage, temperature change, or local damage in the PS steel member itself, thereby severely degrading the structure and safety.

Therefore, it is necessary to monitor changes that occur in a PS steel member inserted inside a PSC girder.

Korean Patent publication no. 10-1144937 is also an invention developed out of this need, wherein the PS steel member exposed at one side of the PSC girder is batted and then the batting force and the axial vibration frequency caused by the batting are measured at the other side of the PSC girder so as to evaluate the tensile stress.

However, it is not possible to use the aforementioned method since a PSC girder generally used when constructing a bridge is usually not separable, and the PS steel member of the PSC girder cannot be exposed either since it is usually finished by concrete when constructing the bridge.

### PRIOR ART DOCUMENT

Patent document 1: Korean Patent publication no. 10-1144937 “Evaluating method and equipment of pre-stressing force of tendon using axial vibration”.

All documents cited in the present disclosure, including published documents, patent applications, and patents, may be incorporated herein in their entirety by reference in the same manner as when each cited document is separately and specifically incorporated or incorporated in its entirety.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A purpose of the present disclosure is to provide a PSC anchorage for monitoring a status change of a PS steel member inserted inside a PSC girder and a PSC girder using the same.

Another purpose of the present disclosure is to provide a PSC anchorage for monitoring in real time a change in a corrosion rate and tensile force of a PS steel member and a PSC girder using the same.

According to an aspect, there is provided a PSC anchorage including an anchorage plate having a central hole through which a PS steel member penetrates; a protruding unit which protrudes from the anchorage plate and through which the PS steel member penetrates; and a metering unit configured to measure information on a state of the PS steel member.

The metering unit may include a magnetizing unit which is disposed on the protruding unit and which is configured to magnetize the PS steel member; and a measuring unit which is disposed on the protruding unit and which is configured to measure a TF (Total Flux) caused by the PS steel member and the magnetizing unit.

The magnetizing unit may include a first coil wound around the protruding unit, and a signal applying line configured to apply a signal to the first coil, and the measuring unit may include a second coil wound around the protruding unit, and a signal output line where a signal from the second coil is output.

The protruding unit may include a protruding tube through which the PS steel member penetrates, and the coil may be wound around the protruding tube.

The protruding tube may have a dual-tube or triple-tube structure, the second coil being wound around a first protruding tube disposed innermost, and the first coil being wound around the second protruding tube that covers the first protruding tube.

The inner diameter of the first protruding tube may correspond to a diameter of a sheath tube into which the PS steel member is inserted.

The second protruding tube may be configured to be attachable to or detachable from the anchorage plate or the first protruding tube.

The protruding tube may be made of an insulating material.

An alternating current for magnetizing may be applied to the signal applying line, and the TF may be measured using an induced voltage measured by the measuring unit.

At least one penetration hole may be formed on the anchorage plate such that the signal applying line and the signal output line may penetrate through the hole.

According to another aspect, there is provided a PSC girder for pre-stressing a PS steel member to offset a stress acting on the PS steel member, wherein a PSC anchorage of any one of claims 1 to 10 is installed at one end of the PSC girder, and one end of the PS steel member penetrates the PSC anchorage and is secured.

A signal applying line where a signal for magnetizing the PS steel member is applied, and a signal output line where a signal measured to determine a state of the PS steel member is output may be exposed from the PSC anchorage to outside the PSC girder.

At the one end of the PSC girder where the PSC anchorage is installed, a space may be provided for a protruding unit of the PSC anchorage to be inserted near a sheath tube.

The PSC girder may be a blocked out PSC girder, and the PSC anchorage may be disposed in the blocked out portion.

Various aforementioned aspects of the present disclosure have an effect of providing a PSC anchorage for monitoring in real time a change in a corrosion rate and tensile stress of a PS steel member and a PSC girder having the same.

Other features and aspects will be apparent from the following detailed description, the drawings, and the claims.

### BRIEF DESCRIPTION OF THE DRAWINGS

FIG. 1 is a diagram illustrating a conventional PSC girder.

FIG. 2 is a diagram illustrating a conventional PSC anchorage installed inside a PSC girder.

FIG. 3 is a perspective diagram illustrating a PSC anchorage according to an embodiment of the present disclosure.

FIG. 4 is a cross-sectional diagram illustrating a PSC anchorage according to an embodiment of the present disclosure.

FIG. 5 is a cross-sectional diagram illustrating a PSC anchorage according to another embodiment of the present disclosure.

FIG. 6 is an exploded perspective diagram illustrating a PSC anchorage according to another embodiment of the present disclosure.

FIG. 7 are diagrams illustrating how a PSC anchorage is installed in a PSC girder according to an embodiment of the present disclosure.

FIG. 8 is a diagram illustrating a blocked-out PSC girder.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses, and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Hereinafter, a portable sensing apparatus according to an embodiment of the present disclosure will be explained with reference to the drawings attached.

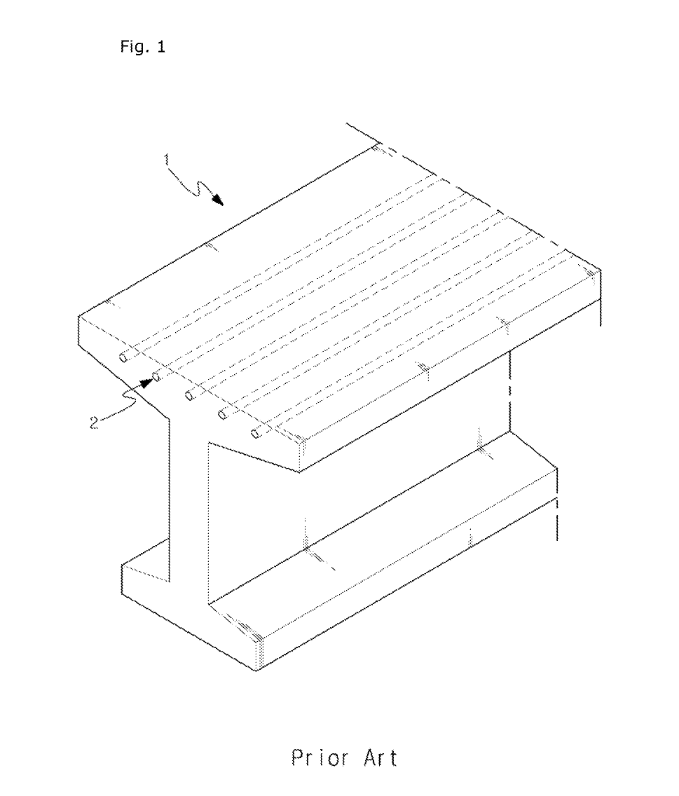

First of all, a general PSC girder is illustrated in FIG. 1.

A PSC girder 1 is generally made by depositing concrete in a concrete-casting mold with sheath tubes 3 installed therein, curing the concrete, dismantling the mold, inserting a PS steel member inside the sheath tubes, applying stress to the PS steel member, and then securing the stressed PS member to an end of the PSC girder. In this way, a pre-stress is applied to the PSC girder.

The PS steel member penetrates the PSC girder from one end to the other end of the PSC girder through the sheath tubes, and upon being pre-stressed, both ends of the PS steel member are each secured to an anchorage existing at both ends.

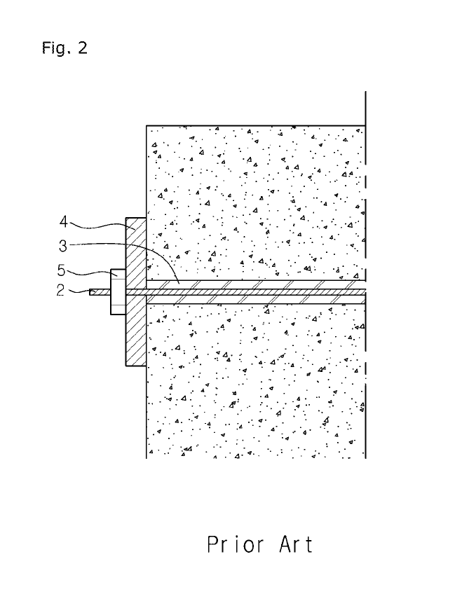

FIG. 2 is a diagram illustrating a PSC anchorage existing at one end of a PSC girder. A conventional anchorage consists of an anchorage plate 4 having a hole through which the PS steel member 2 penetrates, and a wedge 5 that is clamped with the PS steel member 2 to secure the PS steel member to the anchorage plate.

Such a secured PS steel member is installed at first having a designed tensile force which is calculated based on the magnitude and distribution of the stress that acts on the PSC girder, but as time goes by, the tensile force changes, and corrosion may occur. However, once the PSC girder 1 is installed, there is no way to monitor the state of the PS steel member that is installed inside the PSC girder 1.

Thus, a purpose of the present disclosure is to provide a PSC anchorage with a component capable of sensing a state of a PS steel member so as to monitor the state of the PS steel member even after a PSC girder is installed.

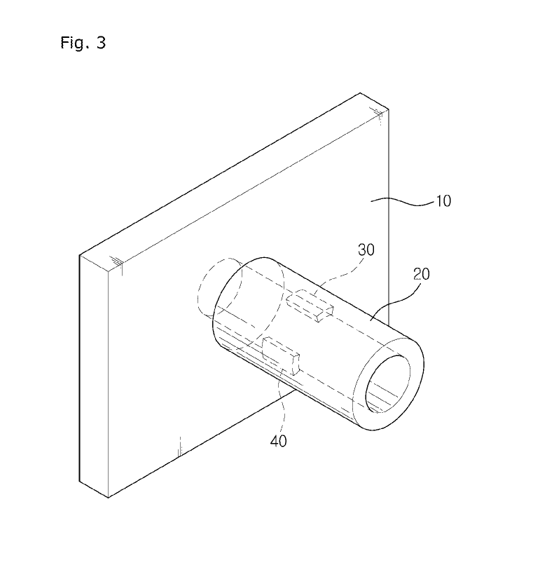

Such a PSC anchorage according to an embodiment of the present disclosure 10 is illustrated in FIGS. 3 to 6. Hereinafter, the PSC anchorage according to the embodiment of the present disclosure 10 will be explained in detail with reference to FIGS. 3 to 6.

The PSC anchorage according to the embodiment of the present disclosure consists of an anchorage plate, a protruding unit, and a metering unit.

The PSC anchorage according to the embodiment of the present disclosure includes the metering unit configured to measure a state of a PS steel member. Based on information on the state of the PS steel member measured by the metering unit, the state of the installed PS steel member may be determined.

FIG. 3 is a perspective diagram illustrating a PSC anchorage according to an embodiment of the present disclosure. The PSC anchorage illustrated in FIG. 3 magnetizes the PS steel member, measures an information of state of the PS steel member caused by the magnetization, and determines the state of the PS steel member based on the measurements.

As illustrated in FIG. 3, the PSC anchorage according to the embodiment of the present disclosure 100 consists of an anchorage plate 10, protruding unit 20, metering unit (specifically including a magnetizing unit 30 and a measuring unit 40).

The anchorage plate 10 is a component configured to secure the PS steel member to the PSC girder together with a wedge (not illustrated). A central hole 11 is formed in the anchorage plate 10 through which the PS steel member penetrates.

The protruding unit 20 is configured such that it protrudes from the anchorage plate. Just as the anchorage plate, the protruding unit 20 has a penetrating unit 21 therein through which the PS steel member penetrates. Therefore, the protruding unit is configured such that it protrudes from near the central hole 11 of the anchorage plate 10, and such that the central hole 11 of the anchorage plate and the penetrating unit 21 of the protruding unit are formed continuously.

The magnetizing unit 30 is a component configured to magnetize the PS steel member that penetrates the anchorage 100. To this end, a component for generating a magnetic field is provided on the protruding unit 20.

The measuring unit 40 is a component configured to measure a TF (Total Flux) caused by the magnetizing unit and the PS steel member. The measuring unit 40 is formed on the protruding unit 20 so as to measure the TF just like the magnetizing unit.

Upon measuring the TF with the measuring unit, it is possible to convert the measured TF into a magnetization history curve (B-H Loop), and analyze the B-H Loop to extract magnetic characteristics such as the permeability and Young's modulus, and then calculate cross-sectional loss of the PS steel member caused by corrosion using the regression analysis and patterns recognition method, thereby estimating the corrosion rate of the PS steel member.

Furthermore, it is possible to measure a change in a relative permeability based on the permeability of an initial stressed state, and estimate the stress loss of the PS steel member.

The anchorage according to the present disclosure 100 is provided with a magnetizing unit 30 configured to magnetize the PS steel member and the measuring unit 40 configured to measure the TF caused by the magnetization in order to monitor the state of the PS steel member. However, the specific method for calculating the tensile force and/or corrosion rate of the PS steel member using the measured TF is not the subject matter of the present disclosure, and thus explanation is omitted.

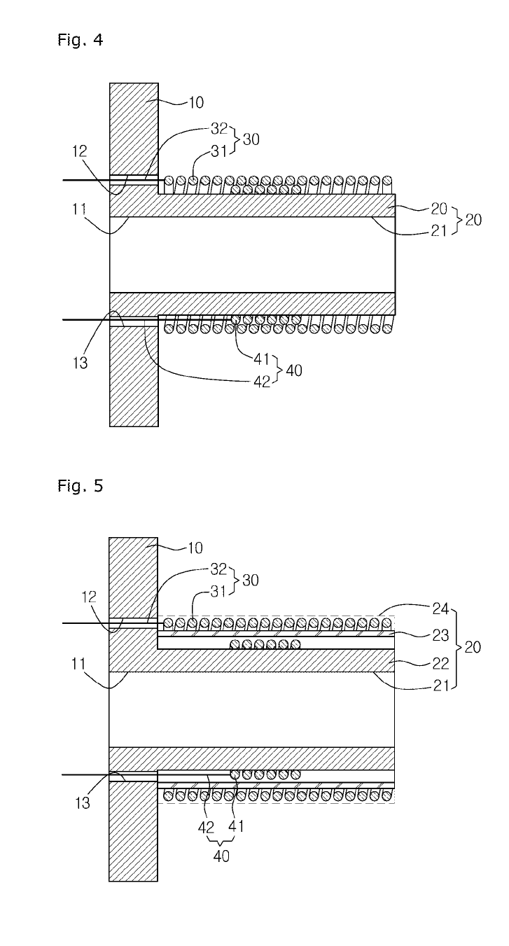

As shown in FIG. 4, in the anchorage 100 according to the embodiment of the present disclosure, the protruding unit 20 may be realized as a tube protruding from the anchorage plate 10, and the magnetizing unit 30 and the measuring unit 40 may be realized as a coil and signal lines wound around the protruding tube.

Specifically, the protruding unit 20 is realized as a protruding tube through which the PS steel member penetrates. An inner diameter of the protruding unit 20 corresponds to an outer diameter of the sheath tube of the PSC girder such that the sheath tube may be inserted into the protruding unit 20, that is, the inner diameter of the protruding unit 20 may be the same as or slightly bigger than the outer diameter of the sheath tube.

The magnetizing unit 30 consists of first coil 31 wound around the protruding tube and a signal applying line 32 configured to apply a signal to the first coil 31, and the measuring unit 40 consists of a second coil 41 wound around the protruding tube and a signal output line 42 through which a signal from the second coil 41 is output.

To the signal applying line 32, an alternating current is provided in order to magnetize the PS steel member penetrating the protruding unit 20, and when the alternating current is applied to the first coil 31 wound around the protruding unit, an induced magnetic field is generated according to an electromagnetic induction law.

Furthermore, the induced magnetic field and the TF (Total Flux) caused by the PS steel member can be measured by the second coil 41, and the measured signal is transmitted outside through the signal output line 42. Specifically, in the second coil, an induced voltage is generated by the induced magnetic field, and through this induced voltage, the TF caused by the induced magnetic field may be measured.

For the sake of convenience of explanation, in the present specification, the portion wound around the protruding unit 20 is referred to as coil, while the line connected to the coil and configured to provide a signal to the coil and/or to output the signal from the coil is referred to as the signal line. However, instead of being differentiated into coil and signal line, the coil and the signal line may be integrally formed as a wire configured to transmit electric signals.

Furthermore, since the alternating signal being provided to the first coil is provided from outside, it may be provided freely so that a strong induced magnetic field is generated, but the second coil must be disposed closer to the PS steel member than the first coil so that the voltage induced by a magnitude of the induced magnetic field is small and the effects by the PS steel member is sensed well. Furthermore, it is preferable that a greater amount of first coil for magnetization is wound around than the second coil as illustrated.

Furthermore, since the signal applying line 32 and signal output line 42 must transmit a signal from outside to the coil and/or transmit the signal of the coil to outside, each end of the signal applying 32 and signal output line 42 must be exposed outside. Therefore, as illustrated in FIG. 4, in the anchorage plate 10, a penetrating hole 12 through which the signal applying line 32 penetrates and a penetrating hole 13 through which through which the signal output line 42 penetrates may be formed.

In FIG. 4, the penetrating hole 12 through which the signal applying line 32 penetrates and the penetrating hole 13 through which the signal output line 42 penetrates are formed separately, but instead, the signal applying line and the signal output line may be formed such that they penetrate the anchorage plate 10 through one penetrating hole and are then exposed outside. Otherwise, without forming a penetrating hole, the coils 31, 32 may be arranged such that they are connected to outside using a space formed between the anchorage 100 and the PSC girder 200.

The anchorage according to an embodiment of the present disclosure 100 may be configured to have a dual or triple tube as illustrated in FIG. 5. Such a multi-tube structure is aimed at spacing the first coil and second coil apart from each other.

Specifically, a first protruding tube 22 is placed innermost and the sheath tube is to be inserted into the first protruding tube. Thus, the first protruding tube may have a size corresponding to the outer diameter of the sheath tube.

A second coil is wound around this first protruding tube 22, and a first coil is wound around a second protruding tube 23 that covers the first protruding tube 22. Furthermore, as illustrated in dotted lines, the protruding tube may be configured in a triple structure, that is, a third protruding tube may be formed as well to cover the second coil such that the second coil is not exposed outside.

Such a protruding tube may be made of an insulating material such as acryl or phenolnormaline resin so as to insulate the first coil and the second coil.

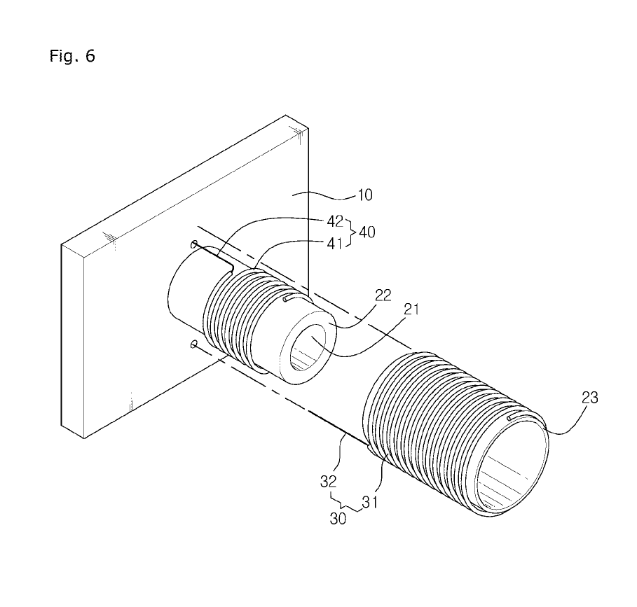

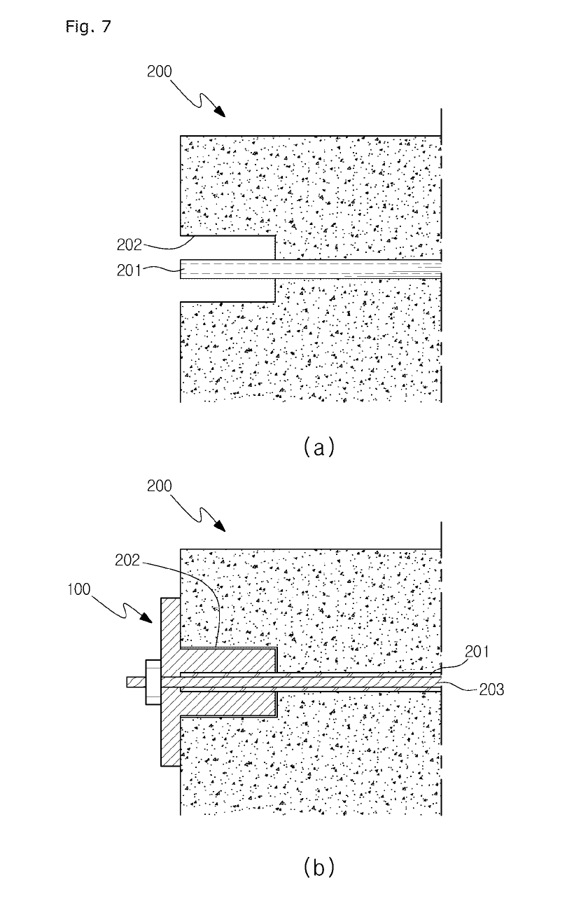

Furthermore, the first protruding tube 22 may be integral with the anchorage plate 10, but preferably, the second protruding tube 23 and third protruding tube 24 may be configured such that they are detachable from the anchorage plate 10 and/or first protruding tube 22. That is, as illustrated in FIG. 6, the anchorage 100 according to the embodiment of the present disclosure having the first coil and second coil wound may be configured by winding the second coil around the first protruding tube 22 that is fixated, and then installing the second protruding unit 23 to cover the second coil such that the second coil is not exposed outside. Otherwise, when forming a triple tube, it is possible to install the third protruding tube 24 on the anchorage plate 10 and/or the second protruding tube such that the first coil wound around the second protruding tube is not exposed outside.

The anchorage 100 according to the embodiment of the present disclosure may be positioned at one side of the PSC girder 200 such that it secures the PS steel member just as in a conventional anchorage. However, the anchorage according to the embodiment of the present disclosure also includes a protruding unit 20 that protrudes from the anchorage plate 10, and thus it is preferable to include in the anchorage a space 202 through which the protruding unit 20 may be inserted into the PSC girder.

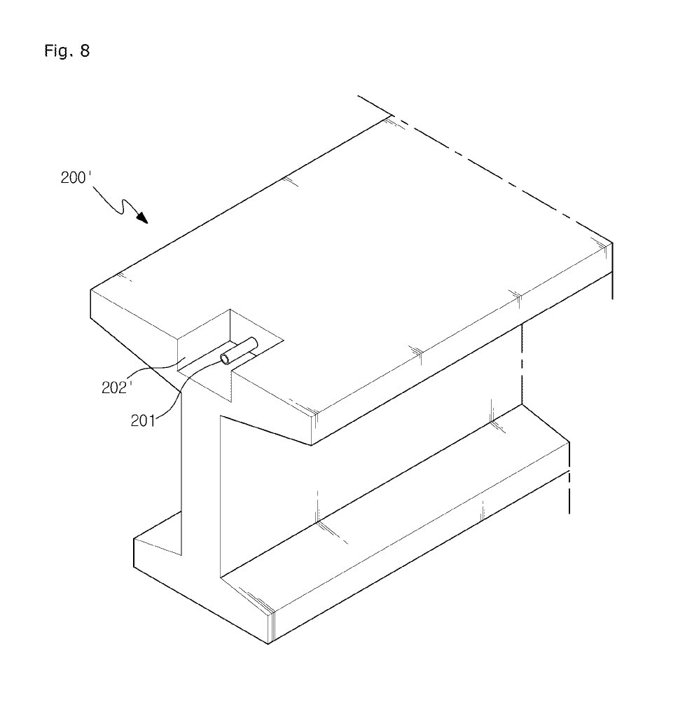

Furthermore, as illustrated in FIG. 8, assuming that the PSC girder is a blocked-out PSC girder, that is, where a portion has been blocked out, it is preferable that the anchorage according to the embodiment of the present disclosure 100 is installed in the blocked out portion 202′.

Furthermore, the signal applying line for applying the alternating signal to the magnetizing unit 30 and the signal output line for outputting the signal measured at the measuring unit 40 are installed such that they may be pulled outside the PSC girder. The signal applying line and the signal output line must be made in sufficient lengths such that they may be exposed outside the surface of the final construction such as a girder bridge wherein the PSC girder is used.

When the signal applying line and the signal output line are exposed outside the final construction, by supplying an alternating current to the signal applying line and analyzing the signal output from the signal output line, it becomes possible to monitor the state of the PS steel material anytime even if the PS steel member installed inside the construction is not exposed outside.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

### REFERENCE NUMERALS

10: ANCHORAGE PLATE
11: CENTRAL HOLE
20: PROTRUDING UNIT
21: PENETRATING UNIT
22: FIRST PROTRUDING UNIT
23: SECOND PROTRUDING UNIT
24: THIRD PROTRUDING UNIT
30: MAGNETIZING UNIT
31: FIRST COIL
32: SIGNAL APPLYING LINE
40: MEASURING UNIT
41: SECOND COIL
42: SIGNAL OUTPUT LINE
100: ANCHORAGE
200: PSC GIRDER
202: SPACE

1. A PSC anchorage comprising:
an anchorage plate having a central hole through which a PS steel member penetrates;
a protruding unit which protrudes from the anchorage plate and through which the PS steel member penetrates; and
a metering unit configured to measure information on a state of the PS steel member.

2. The PSC anchorage of claim 1,
wherein the metering unit comprises:
a magnetizing unit which is disposed on the protruding unit and which is configured to magnetize the PS steel member; and
a measuring unit which is disposed on the protruding unit and which is configured to measure a TF (Total Flux) caused by the PS steel member and the magnetizing unit.

3. The PSC anchorage of claim 2,
wherein the magnetizing unit comprises a first coil wound around the protruding unit, and a signal applying line configured to apply a signal to the first coil, and
wherein the measuring unit comprises a second coil wound around the protruding unit, and a signal output line where a signal from the second coil is output.

4. The PSC anchorage of claim 3,
wherein the protruding unit comprises a protruding tube through which the PS steel member penetrates, and
wherein the coil is wound around the protruding tube.

5. The PSC anchorage of claim 4,
wherein the protruding tube has a dual-tube or triple-tube structure, the second coil being wound around a first protruding tube disposed innermost, and the first coil being wound around the second protruding tube that covers the first protruding tube.

6. The PSC anchorage of claim 5,
wherein an inner diameter of the first protruding tube corresponds to a diameter of a sheath tube into which the PS steel member is inserted.

7. The PSC anchorage of claim 5,
wherein the second protruding tube is configured to be attachable to or detachable from the anchorage plate or the first protruding tube.

8. The PSC anchorage of claim 5,
wherein the protruding tube is made of an insulating material.

9. The PSC anchorage of claim 3,
wherein an alternating current for magnetizing is applied to the signal applying line, and wherein the TF is measured using an induced voltage measured in the measuring unit.

10. The PSC anchorage of claim 3,
wherein at least one penetration hole is formed on the anchorage plate such that the signal applying line and the signal output line may penetrate through the hole.

11. A PSC girder for pre-stressing a PS steel member to offset a stress acting on the PS steel member,
wherein a PSC anchorage of claim 1 is installed at one end of the PSC girder, and one end of the PS steel member penetrates the PSC anchorage and is secured.

12. The PSC girder of claim 11,
wherein a signal applying line where a signal for magnetizing the PS steel member is applied, and a signal output line where a signal measured to determine a state of the PS steel member is output are exposed from the PSC anchorage to outside the PSC girder.

13. The PSC girder of claim 11,
wherein at the one end of the PSC girder where the PSC anchorage is installed, a space is provided for a protruding unit of the PSC anchorage to be inserted near a sheath tube.

14. The PSC girder of claim 11,
wherein the PSC girder is a blocked-out PSC girder, and the PSC anchorage is disposed in the blocked out portion.
